(19) United States
(12) Patent Application Publication
(10) Pub. No.: US 2007/0101773 A1
(43) Pub. Date: May 10, 2007

(54) Drum washing machine

(75) Inventors: Jae Ryong Park, Suwon-si (KR); Hyung Gyoon Kim, Suwon-si (KR); Sang Yeon Pyo, Suwon-si (KR); Sun Park, Seoul (KR); Sung Wook Kang, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/500,513

(22) Filed: Aug. 8, 2006

(30) Foreign Application Priority Data
Nov. 8, 2005 (KR) 10-2005-0106531

(51) Int. Cl. D06F 37/00; B08B 3/12; D06F 25/00

(52) U.S. Cl. 68/5 C; 68/139; 68/3 R; 68/5 R

(57) ABSTRACT

A drum washing machine, in which scale deposited in a steam generating device installed for improving sterilizing and washing capacities is efficiently eliminated. The drum washing machine includes a housing; a tub for containing washing water; a drum rotatably installed in the tub; and a steam generating device installed in the housing for supplying steam for sterilizing laundry to the drum, wherein a scale eliminating unit is installed in a water supply channel of the steam generating device, and includes at least one protrusion formed on the inner circumferential surface of the water supply channel or a water supply valve and a pulsation circuit for controlling the flow rate and amount of the water. The scale eliminating unit forms turbulence in the steam generating device or supplies water having varied flow rate and amount to the steam generating device, thereby efficiently eliminating scale deposited in the steam generating device.

### CROSS-REFERENCE TO RELATED APPLICATIONS

This application claims the benefit of Korean Patent Application No. 2005-0106531, filed Nov. 8, 2005, in the Korean Intellectual Property Office, the disclosure of which is incorporated herein by reference.

### BACKGROUND OF THE INVENTION

1. Field of the Invention

The present invention relates to a drum washing machine, and more particularly, to a drum washing machine having a steam generating device for spraying steam of a high temperature to a rotary drum to improve sterilizing and washing capabilities.

2. Description of the Related Art

Generally, a drum washing machine sequentially performs washing, rinsing, and dehydrating operations by the rotation of a drum, which is rotatably installed in a horizontal tub using driving force of a motor under the condition that detergent, water, and laundry are placed into the drum, thereby washing the laundry in the drum.

Recently, various supplementary functions designed to satisfy user's tastes besides a particular washing function have been added to the drum washing machine. For example, Korean Patent Application No. 2003-0015003 discloses a drum washing machine having a hot air generating device, which blows hot air into a tub so as to rapidly dry laundry. Further, Korean Utility Model Registration No. 20-0397085 discloses a drum washing machine having a steam generating device, which sprays hot steam into a rotary drum so as to improve sterilizing and washing capabilities.

Since the above steam generating device generates steam by heating tap water, when the steam generating device is used over a long period of time, scale accumulates in the steam generating device due to hard water components, such as magnesium ions (Mg++) or calcium ions (Ca++). The scale gradually builds up in a water channel of the steam generating device, thereby causing an increase in flow resistance, and, in the worst case, causing the channel to be closed.

### SUMMARY OF THE INVENTION

Therefore, one aspect of the invention is to provide a drum washing machine having a scale eliminating unit for efficiently eliminating scale deposited in a steam generating device.

In accordance with one aspect, the present invention provides a drum washing machine including: a housing; a tub for containing washing water; a drum rotatably installed in the tub; and a steam generating device installed in the housing for supplying steam for sterilizing laundry to the drum, wherein a scale eliminating unit including at least one protrusion formed on the inner circumferential surface of a water supply channel of the steam generating device is installed in the water supply channel.

In accordance with another aspect, the present invention provides a drum washing machine including: a housing; a tub for containing washing water; a drum rotatably installed in the tub; and a steam generating device installed in the housing for supplying steam for sterilizing laundry to the drum, wherein a water supply channel of the steam generating device branches into a first channel for supplying water to the steam generating device in a washing operation and a second channel for supplying water to the steam generating device in a rinsing operation, and a scale eliminating unit including a water supply valve and a pulsation circuit for controlling the flow rate and amount of the water is installed in the second channel.

In accordance with yet another aspect, the present invention provides a drum washing machine including: a housing; a tub for containing washing water; a drum rotatably installed in the tub; and a steam generating device installed in the housing for supplying steam for sterilizing laundry to the drum, wherein a scale eliminating unit is installed in a water supply channel of the steam generating device, and includes a water supply valve and a pulsation circuit for controlling the flow rate and amount of supplied water.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a perspective view of a drum washing machine of the present invention;

FIG. 2 is a longitudinal sectional view of the drum washing machine of the present invention;

FIG. 3 is a sectional view of a scale eliminating unit of a steam generating device of a drum washing machine in accordance with one embodiment of the present invention;

FIG. 4 is a sectional view of a scale eliminating unit of a steam generating device of a drum washing machine in accordance with another embodiment of the present invention; and

FIG. 5 is a sectional view of a scale eliminating unit of a steam generating device of a drum washing machine in accordance with yet another embodiment of the present invention.

### DETAILED DESCRIPTION OF THE PREFERRED EMBODIMENTS

Reference will now be made in detail to the embodiment of the present invention, an example of which is illustrated in the accompanying drawings, wherein like reference numerals refer to like elements throughout. The embodiment is described below to explain the present invention by referring to the annexed drawings.

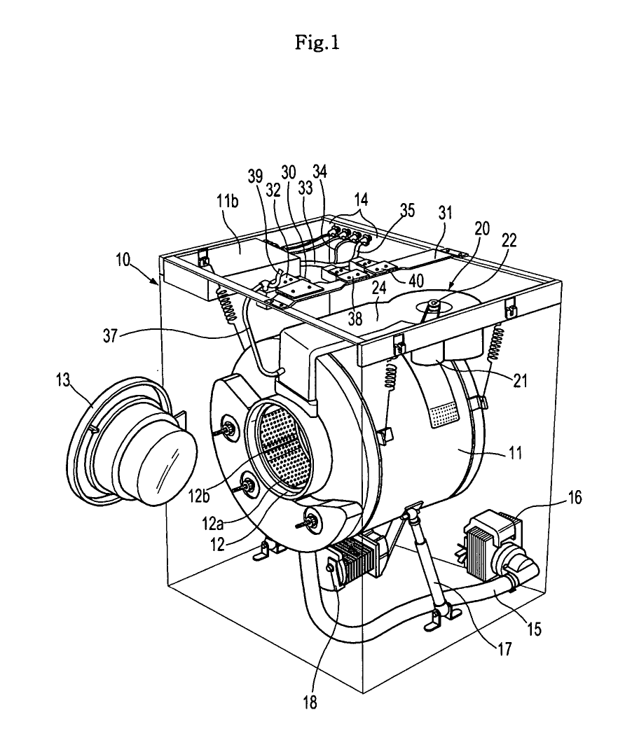

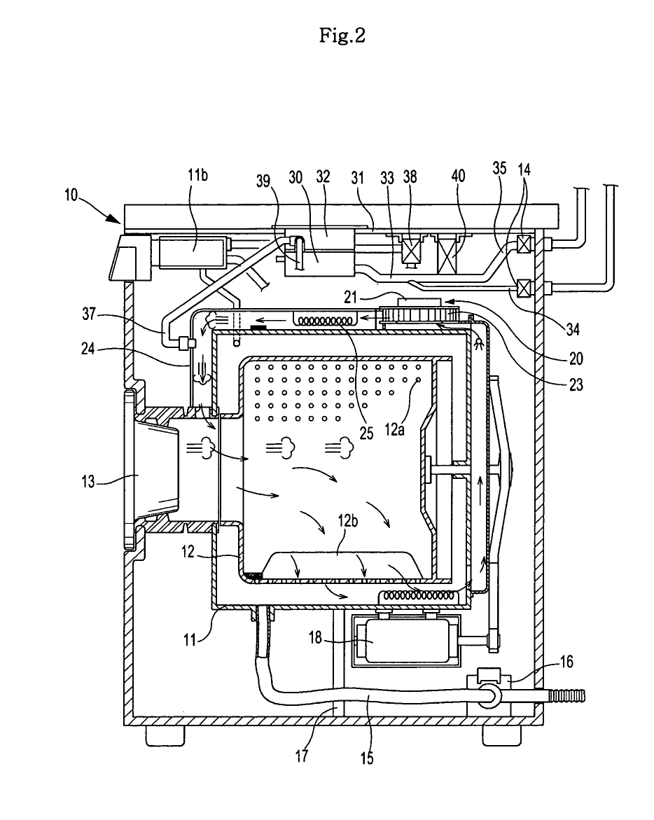

FIGS. 1 and 2 are perspective and longitudinal sectional views of a drum washing machine of the present invention.

With reference to FIGS. 1 and 2, the drum washing machine of the present invention includes a housing 10 forming the external appearance of the washing machine, a cylindrical tub 11 installed in the housing 10 for containing washing water, and a cylindrical drum 12 rotatably installed in the tub 11.

Openings are respectively formed through the front surfaces of the tub 11 and the drum 12 so that a user can put laundry into and take the laundry out of the washing machine therethrough. A door 13 is hinged to one side of the front surface of the housing 10 such that the door 13 can open and close the openings of the tub 11 and the drum 12.

A water supply device 14 for supplying the washing water and a detergent supply device 11b for mixing a detergent with the supplied washing water are installed above the tub 11. The water supply device 14 includes a plurality of valves connected to an external water supply source for selectively controlling the supply of the washing water to the detergent supply device 11b, a nano silver generator 38, and a steam generating device 30.

A drain pipe 15 and a drain pump 16 for discharging the washing water to the outside and a suspension device 17 for absorbing vibration generated from the rotation of the drum 12 are installed below the tub 11.

The drum 12 is rotated by rotary force generated from a driving motor 18 installed in the lower portion of the inside of the housing 10, and through holes 12a for passing the washing water stored in the tub 11 are formed through the outer circumferential surface of the drum 12. A plurality of lifters 12b are installed on the inner surface of the drum 12, thereby lifting and then dropping the laundry by the rotation of the drum 12 so that the laundry is washed.

A hot air supply device 20 for supplying hot air to rapidly dry the laundry after a washing operation is installed in the upper portion of the inside of the housing 10.

As shown in FIG. 2, the hot air supply device 20 includes a motor 21 for generating driving force, a fan 23 connected to the motor 21 by a belt 22 (FIG. 1) and rotated, a drying duct 24 for guiding air, supplied by the rotary force of the fan 23, to the tub 11, and a heater 25 installed in the drying duct 24 for heating the air, supplied by the rotary force of the fan 23. Since the drying duct 24 is connected to the upper portion of the front surface of the tub 11, the hot air heated by the heater 25 is supplied to the tub 11, thereby rapidly drying the laundry under the condition that the laundry is rotated.

The steam generating device 30 for spraying steam to improve sterilizing and washing capacities of the drum washing machine is installed in the upper portion of the inside of the housing 10. The steam generating device 30 is installed on a support plate 31, crossing the central portion of the housing 10, by a bracket 32 so that the steam generating device 30 is easily assembled with and disassembled from the housing 10.

A direct water-type steam generating device, which causes the supplied water to be gradually introduced into an internal heater (not shown) for rapidly converting the water into steam, may be used as the steam generating device 30. One end of the steam generating device 30 is connected to a water supply channel 33 so that water can be supplied from the water supply device 14 to the steam generating device 30, and the other end of the steam generating device 30 is connected to the drying duct 24 of the hot air supply device 20 by a steam pipe 37 so that the generated steam can be supplied to the drum 12.

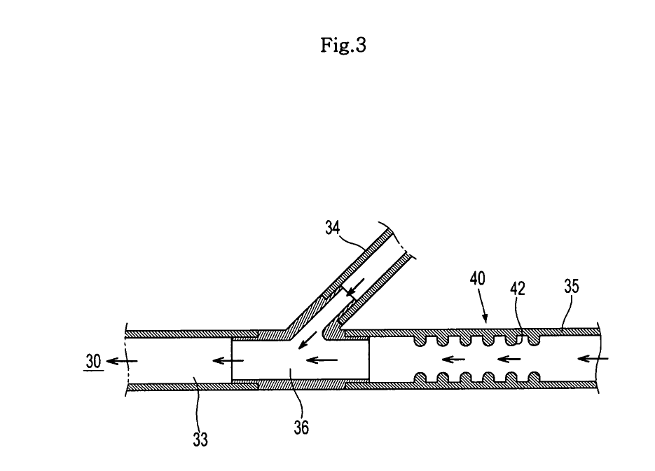

In the drum washing machine of the present invention, a scale eliminating unit 40 for eliminating scale gradually deposited in the steam generating device 30 is installed in the water supply channel 33 for supplying water to the steam generating device 30. FIGS. 3 to 5 respectively illustrate various scale eliminating units employed by the drum washing machine of the present invention, and a detailed description thereof will be described later.

The water supply channel 33 of the steam generating device 30, in which the scale eliminating unit 40 is installed, branches into first and second channels 34 and 35. The first channel 34 has sectional dimensions smaller than the sectional dimensions of the second channel 35. The first channel 34 serves to supply water to the steam generating device 30 in a washing operation, and the second channel 35 serves to supply water the steam generating device 30 in a rinsing operation. The first and second channels 34 and 35 are interconnected by a coupler 36, and is connected to the steam generating device 30.

The scale eliminating unit 40 may be installed in the second channel 35. The reason is that a small amount of water is required to generate steam and a large amount of water is required to eliminate scale.

Here, reference numeral 38 refers to a nano sliver generator, both ends of which are connected to the water supply device 14 and the tub 11 by separate water supply and discharge pipes, for supplying the washing water containing silver ions to the tub 11, and reference. numeral 39 refers to a bypass channel serving as a safety device for preventing the internal pressure of the steam generating device 30 from rising greater than a designated value when the steam generating device 30 is closed. Identical to the steam generating device 30, the nano silver generator 38 and the scale eliminating unit 40 are installed on the support plate 31 of the housing 10 so that the nano silver generator 38 and the scale eliminating unit 40 are easily attached to and detached from the housing 10.

FIG. 3 illustrates a scale eliminating unit in accordance with one embodiment of the present invention. With reference to FIG. 3, the scale eliminating unit 40, which is installed in the second channel 35, as described above, includes at least one protrusion 42 protruded from the inner circumferential surface of the second channel 35. The protrusion 42 may have one sectional shape selected from the group consisting of a circle, a triangle, a polygon, etc. Accordingly, when water passes through the second channel 35 with the protrusion 42, the water collides with the protrusion 42 to generate turbulence. Thereby, it is possible to easily eliminate scale deposited in the steam generating device. The above protrusion 42 may be formed in the steam generating device 30.

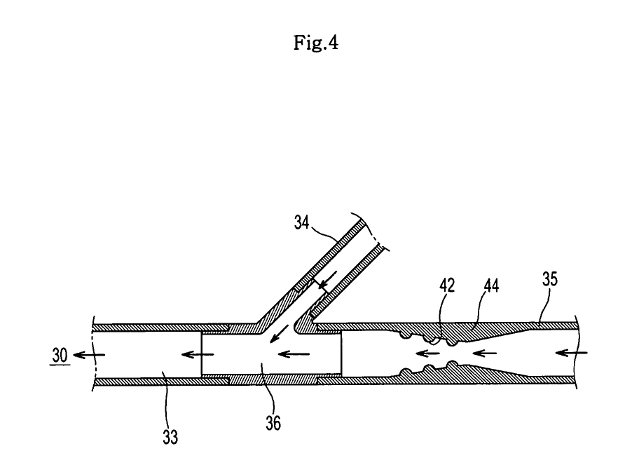

FIG. 4 illustrates a scale eliminating unit in accordance with another embodiment of the present invention. The scale eliminating unit 44 serves to vary the sectional dimensions of the second channel 35 in the longitudinal direction so that the supplied water generates larger turbulence. For example, as shown in FIG. 4, when the scale eliminating unit 44 decreases and then increases the sectional dimensions of the second channel 35 having one end connected to the water supply device and the other end connected to the tub, the flow rate of the water in the second channel 35 is varied, thereby generating larger turbulence. When at least one protrusion 42 is further formed in the second channel 35, the water in the second channel 35 generates severer turbulence.

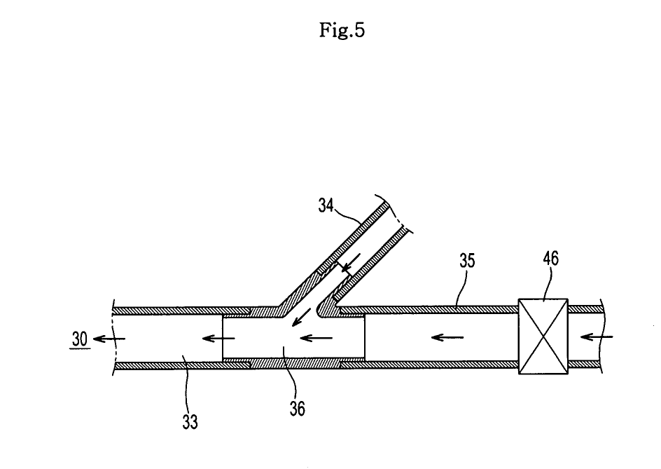

FIG. 5 illustrates a scale eliminating unit in accordance with yet another embodiment of the present invention. The scale eliminating unit of this embodiment includes a valve 46 installed at one end thereof, to which water is supplied. In order to eliminate scale deposited in the steam generating device 30, the valve 46 is closed, and is then temporarily opened so that a large amount of water is supplied to the steam generating device 30, thereby selectively controlling the flow rate and amount of the water introduced into the steam generating device 30. Accordingly, it is possible to eliminate the scale deposited in the steam generating device 30.

A pulsation circuit may be electrically connected to the valve 46. The pulsation circuit periodically or non-periodically controls the supply of a pulse signal, and thus controls the opening and closing of the valve 46 and the opening degree of the valve 46, thereby controlling the intermittent supply of the water introduced into the steam generating device 30 and efficiently eliminating the scale deposited in the steam generating device 30.

Hereinafter, a scale-eliminating operation of a steam generating device of the above-mentioned drum washing machine of the present invention will be described.

As described above, the water supply channel 33 of the steam generating device 30 branches into two channels 34 and 35. In the washing operation, water, which is introduced into the first channel 34 having a smaller radius, is converted into steam by the steam generating device 30, and the steam is supplied to the drum 12 through the drying duct 24.

In the rinsing operation after the washing operation, the water supply device 14 closes the first channel 34, and opens the second channel 35. Then, the scale eliminating unit 40 in the second channel 35 is operated to form turbulence or to supply water having varied flow rate and amount to the steam generating device 30, thereby efficiently eliminating scale deposited in the steam generating device 30.

As apparent from the above description, the present invention provides a drum washing machine having a steam generating device, which include a scale eliminating unit for generating turbulence of water or supplying water having varied flow rate and amount to the steam generating device, thereby efficiently eliminating scale, deposited in the steam generating device due to hard water components, such as magnesium ions (Mg++) or calcium ions (Ca++).

Although embodiments of the invention have been shown and described, it would be appreciated by those skilled in the art that changes may be made in this embodiment without departing from the principles and spirit of the invention, the scope of which is defined in the claims and their equivalents.

What is claimed is:

1. A drum washing machine comprising:
a housing;
a tub for containing washing water;
a drum rotatably installed in the tub; and
a steam generating device installed in the housing for supplying steam for sterilizing laundry to the drum,
wherein a scale eliminating unit is installed in a water supply channel of the steam generating device.

2. The drum washing machine as set forth in claim 1, wherein the scale eliminating unit comprises at least one protrusion formed on the inner circumferential surface of the water supply channel.

3. The drum washing machine as set forth in claim 1, wherein the water supply channel has internal sectional dimensions varied in the longitudinal direction.

4. The drum washing machine as set forth in claim 3, wherein the internal sectional dimensions of the water supply channel are decreased and then increased in the longitudinal direction.

5. The drum washing machine as set forth in claim 3, wherein the water supply channel branches into a first channel for supplying water to the steam generating device in a washing operation and a second channel for supplying water to the steam generating device in a rinsing operation.

6. The drum washing machine as set forth in claim 5, wherein the scale eliminating unit is connected to the second channel.

7. The drum washing machine as set forth in claim 6, wherein the scale eliminating unit further comprises a water supply valve for controlling the flow rate and amount of the water.

8. The drum washing machine as set forth in claim 7, further comprising a pulsation circuit for controlling the water supply valve so that the supply of the water to the steam generating device is intermittent.

9. A drum washing machine comprising:
a housing;
a tub for containing washing water;
a drum rotatably installed in the tub; and
a steam generating device installed in the housing for supplying steam for sterilizing laundry to the drum, wherein:
a water supply channel of the steam generating device branches into a first channel for supplying water to the steam generating device in a washing operation and a second channel for supplying water to the steam generating device in a rinsing operation; and
a scale eliminating unit is installed in the second channel.

10. The drum washing machine as set forth in claim 9, wherein the scale eliminating unit comprises a water supply valve for controlling the flow rate and amount of the water.

11. The drum washing machine as set forth in claim 10, further comprising a pulsation circuit for controlling the water supply valve so that the supply of the water to the steam generating device is intermittent.

12. A drum washing machine comprising:
a housing;
a tub for containing washing water;
a drum rotatably installed in the tub; and
a steam generating device installed in the housing for supplying steam for sterilizing laundry to the drum,
wherein a scale eliminating unit is installed in a water supply channel of the steam generating device, and comprises a water supply valve and a pulsation circuit for controlling the flow rate and amount of supplied water.

13. A method of eliminating scale in a water supply channel of a steam generating device comprising forming at least one protrusion on the inner circumferential surface of the water supply channel.

14. The method as set forth in claim 13, further comprising varying the internal sectional dimensions of the water supply channel in the longitudinal direction.

15. The method as set forth in claim 14, wherein the internal sectional dimensions of the water supply channel are decreased and then increased in the longitudinal direction.

16. The method as set forth in claim 13, further comprising branching the water supply channel into a first channel for supplying water to the steam generating device in a washing operation and a second channel for supplying water to the steam generating device in a rinsing operation.

17. The method as set forth in claim 16, wherein the protrusion is formed in the second channel.

18. The method as set forth in claim 13, further comprising controlling the flow rate and amount of the water to the water supply channel using a water supply valve.

19. The method as set forth in claim 18, further comprising controlling the water supply valve so that the supply of the water to the steam generating device is intermittent using a pulsation circuit.
